(19) United States
(12) Patent Application Publication
(10) Pub. No.: US 2002/0133816 A1
(43) Pub. Date: Sep. 19, 2002

(54) System for collecting data concerning received transmitted material

(76) Inventors: Steven Bradford Greene, Kent (GB); Peter Edward Paul Murphy, London (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/120,128

(22) Filed: Apr. 10, 2002

Related U.S. Application Data
(63) Continuation of application No. 09/219,033, filed on Dec. 23, 1998.

(30) Foreign Application Priority Data
Jun. 21, 1994 (GB) 9412440.1

(51) Int. Cl. H04N 7/16; H04H 9/00

(52) U.S. Cl. 725/13; 725/9

(57) ABSTRACT

A data collection system for collecting data concerning participant response to broadcast material. The system comprises broadcast material, a plurality of data collection units and a central controller. The broadcast material contains a combination of an audience content portion, which is presented to the participant, and a data content portion which is not presented to the participant but has a content capable of identifying the content of the audience content portion currently being broadcast for presentation to the participant. The data collection units collect and store the data content portions pertaining to participant response to broadcast material and the data content portions stored by the collection unit can be read by the central controller and used for a variety of purposes.

This invention relates to a data collection system for collecting data. More particularly, it relates to a system for collecting data concerning transmitted material received by a participant, for example the attention of a participant to the received transmitted material. The invention also relates to a system for collecting data concerning viewing of television advertisements and programmes.

For information or merchandise transmitted via the television broadcast media, be they programmes or advertisements, a problem arises in that it is difficult to obtain data relating to audience viewing data. It is a further problem to obtain data which correlates such programme and advertisement viewing with socio-geodemographic data of the viewer.

Various systems have been employed to obtain one or both of the aforementioned data. For example, market researchers can be employed to ask viewers, directly or by telephone, the amount of television that is watched, which programmes and advertisements are watched, which days and times are preferred etc. It will be appreciated that the accuracy of this type of data is highly dependent on the honesty and memory of those questioned. In another example, viewing patterns are monitored by videoing the viewers themselves or by videoing the entire period of time whilst a viewer has the television turned on. However, those examples are somewhat intrusive and only give generalised data requiring considerable manual analysis.

In addition, hitherto, the transfer of or interaction with the information in the transmitted material to or by a participant has required expensive apparatus thereby limiting the scope of such transfer.

It is an object of the present invention to provide an improved data collection system which overcomes the aforementioned problems.

It is also an object of the present invention to provide a more readily available transfer of or interaction with information in the transmitted material.

According to the present invention there is provided a data collection system for collecting data concerning participant response to received transmitted material, the system comprising:

a plurality of data collection units distributed, in use, to remote system participants, wherein each said data collection unit has a unique identity and comprises:

a receiving means for receiving the transmitted material;

an information storage means; and

a response means responsive to a manual operation of the unit to store data of a portion of the transmitted material to the information storage means of that unit;

wherein the system further comprises a central controller having means for storing data relating to system participants according to said unique identity; means for reading the unique identity of a data collection unit information storage means; and means for reading the data that has been stored thereon in response to manual operation of that unit.

In this way, the information storage means of the plurality of data collection units can be read by the central controller so that the information representative of the participant response to the received transmitted material can be correlated with the stored date relating to the system participant. On the basis of the data provided, it is possible to ascertain the number of the participant responses to certain transmitted material, such as advertisements, together with the socio-geodemographic factors associated therewith. As an example, it would be possible to ascertain the number of participants who watched a particular advertisement and the number of, say, male participants who watched a particular advertisement.

Preferably, the data collection unit further comprises a display means.

Thus, the storage of the data can be visually indicated to the participant.

It is preferred that said unit actuates said display means to display a predetermined indication when the volume of data stored by the information storage means has reached a predetermined capacity.

As a result, the participant knows when the data contained in the information storage unit should be passed to the central controller.

In one embodiment, the predetermined capacity corresponds to an average volume of data stored by a participant for a period of one to twelve weeks.

This has been found to be a convenient turn round time for the data stored.

In a preferred embodiment, the data collection unit further comprises a memory means and said response means is responsive to a manual operation of the unit whereby data of a portion of the transmitted material is stored by the memory means of that unit.

As a result, further specific data contained in the transmitted material can be stored, for example telephone numbers, addresses etc.

Conveniently, the data collection unit further comprises a manually operable display switch means for actuating the data collection unit to operate to display stored data.

As a result, the further specific data can be easily and readily retrieved for later use.

In one embodiment, said information storage means is removable from the data collection unit to enable physical sending thereof to the location of the central controller.

This enables particularly convenient data collection by the moans for reading.

Preferably, said information storage means comprises a smartcard.

Smartcards are a convenient, easy and cost effective way in which to store information so that the data collection units can be constructed and run in a simple and cost effective manner.

In another embodiment, said means for reading comprises an electronic receiving moans for remote communication with said information storage means.

Therefore, the reading can take place remotely by means of an electronic transmission, say via a modem or the like. This enables convenient data collection by the means for reading.

It is preferred that the data collection unit is manually operated by manually operating a push switch.

In one embodiment, the response means stores said data to the information storage means only during continuous manual operation of that unit.

As a result, the participant must take and maintain a physical action to ensure storage of data.

It is preferred that the response means allocates units and/or units of time during storing said data to the information storage means.

This enables easy collation of data.

Conveniently, said unit of time comprises one second.

In a preferred embodiment, the means for reading data can read the accumulated units of time allocated during storing data and said central controller allocates a value amount according to the total accumulated units.

In this way, participants can be motivated to participate.

Conveniently, said value amount comprises a monetary value, benefit, discount, discount points, benefit, or monies worth.

Thus, either money or equivalent in some form or other can be issued.

Preferably, said means for receiving includes means for decoding the transmitted material; wherein the transmitted material includes a coded section for identifying that transmitted material.

By using transmitted material including coding, the data on the information storage units returned to the central controller can be easily analyzed because the coding provides a way to search for participants in relation to certain transmitted material.

In one embodiment, said coded section includes transmission time and date information; and wherein the response means stores the transmission time and date information with the data stored to the information storage means.

Preferably, the data collection unit further comprises a clock means; and wherein said response means stores the unit time and date with the data stored to the information storage means.

Thus, analysis of the data read from the information storage units by the central controller can therefore indicate whether a time delay has occurred in the participant response relative to the actual transmission time. In this way, it is possible to ascertain whether the transmitted material, say a television advertisement, has been viewed live as opposed to via home video recording.

Conveniently, each data collection unit has a separate manually operable hand hold unit whereby the response means is responsive to a manual operation of the hand hold unit.

Accordingly, the participant need only have and operate a hand held unit. The unit may conveniently be of a similar size to a television remote control.

It is preferred that the hand held unit communicates with the response means by means of an infrared communication link.

In one embodiment, the hand hold unit is capable of supplying the response means with user data concerning the number of current users at the participant location; and wherein the response means stores that user data with the data stored to the Information storage means.

In another embodiment, the hand hold unit comprises a left dedicated switch and a right dedicated switch whereby the response means is responsive to a manual operation of the left and/or right dedicated switch.

This facilitates a more interesting participation.

Preferably, the response means is only responsive to a manual operation of the loft and/or right dedicated switch according to switch data contained in the transmitted material.

Consequently, a system participant abusing the data collection system by say taping down a switch would find that the cut out means inhibits data collection. Such an inhibition can be temporary or complete.

In one case, the data collection unit comprises a left light and a right light actuated according to said switch.

Preferably, the data collection unit further comprises a printer means.

An example of the present invention will now be described, with reference to the accompanying drawings, in which:

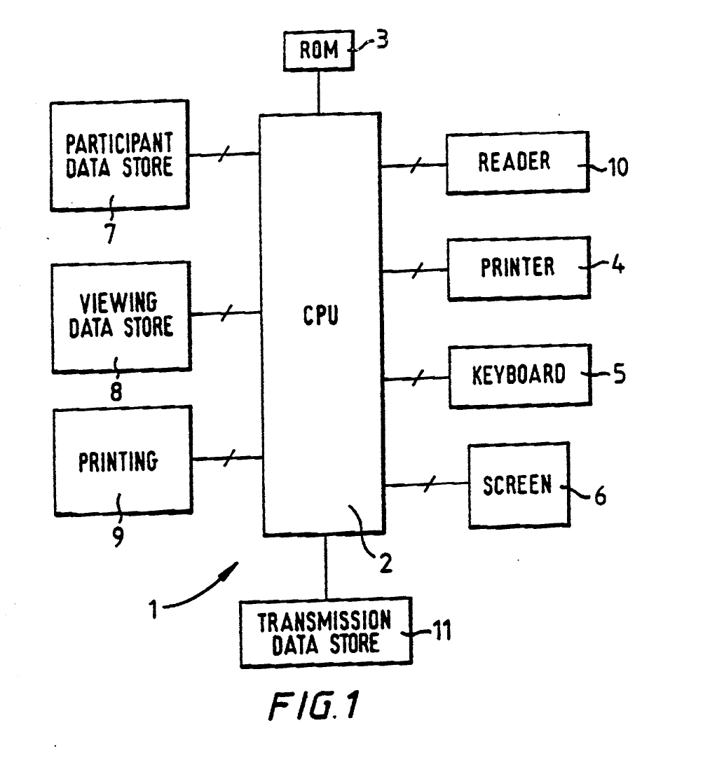

FIG. 1 illustrates a central controller of a first embodiment of the present invention;

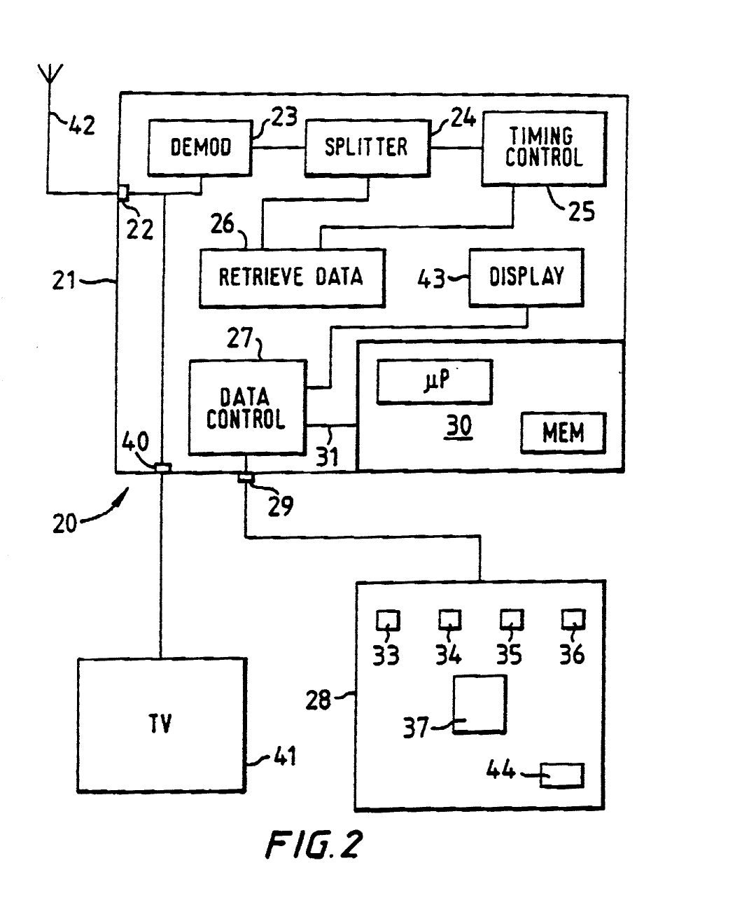

FIG. 2 illustrates a data collection unit of a first embodiment of the present invention at a participant location;

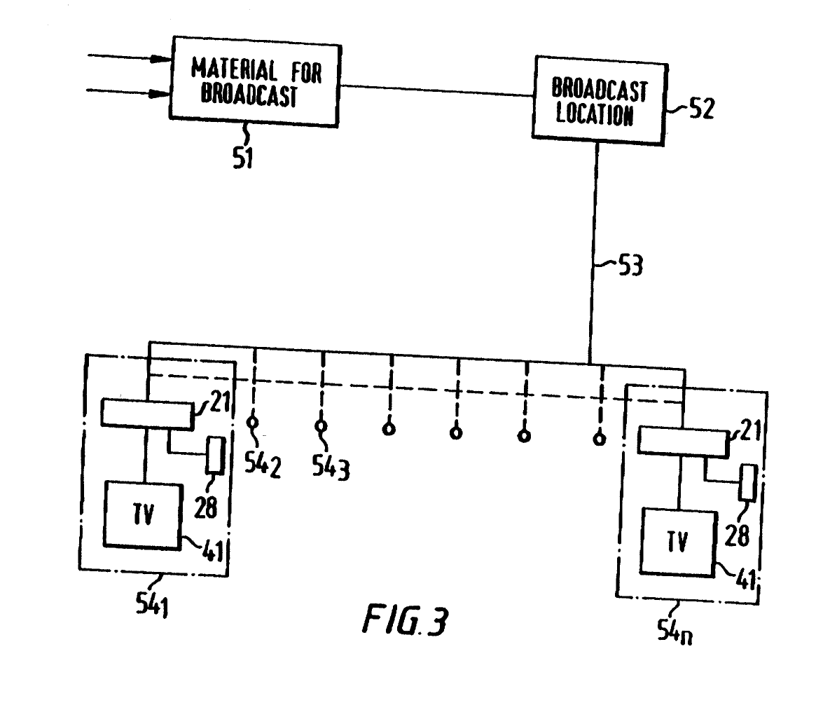

FIG. 3 is a schematic overview of the system of a first embodiment of the present invention;

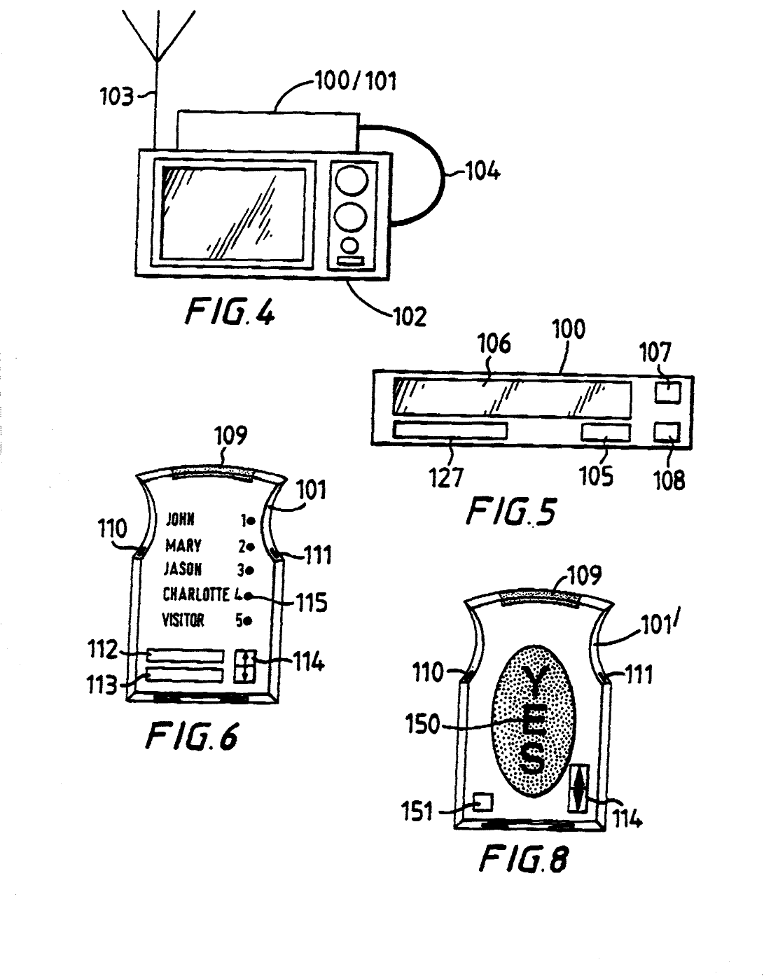

FIG. 4 illustrates a date collection unit of a second embodiment of the present invention at a participant location;

FIG. 5 illustrates a processing unit of a second embodiment of the present invention;

FIG. 6 illustrates a hand hold unit of a second embodiment of the present invention;

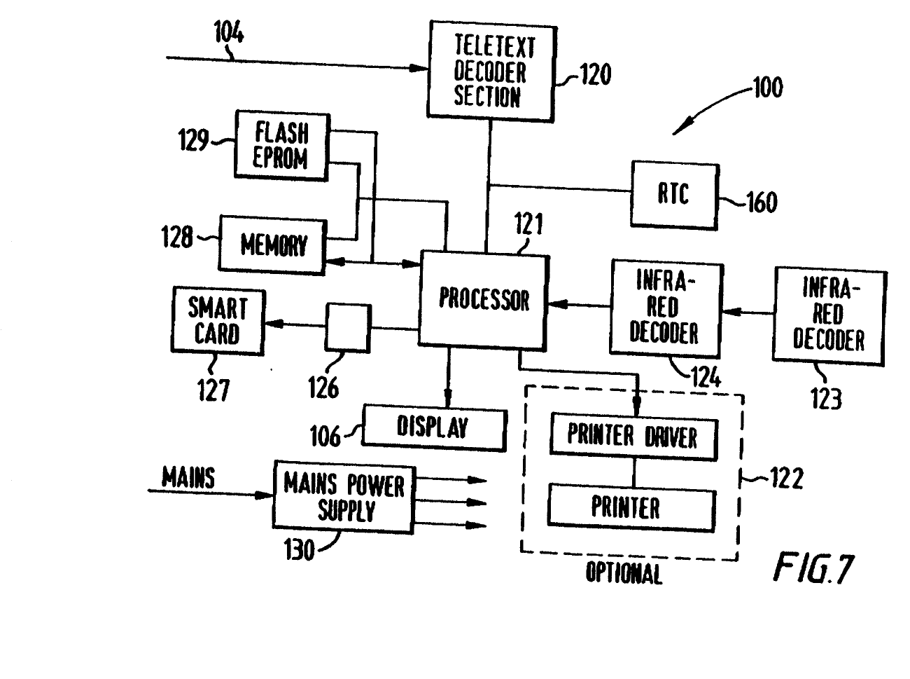

FIG. 7 illustrates a circuit for the processing unit shown in FIG. 5;

FIG. 8 illustrates a hand hold unit of another embodiment of the present invention.

The present invention will be described in relation to television advertisements, but this is only by way of example.

Referring to FIG. 1, a central controller 1 comprises a main central processing unit (CPU) 2 connected to a road only memory 3 storing control programs for the controller. The CPU 2 is also connected to conventional peripherals in the form of a printer 4, a keyboard 5 and a screen 6. The CPU 2 is also connected to a participant data store 7, a viewing data store 8, and a transmission data store 11. These are illustrated separately for the purpose of clarity, but may of course be partitioned sections of a single memory unit. A dedicated printing unit 9 may also be connected for printing vouchers or coupons. The functions of this printer could be amalgamated with the printer 4. Finally, a reader unit 10 is connected to the CPU 2, the function of which will become apparent hereinafter.

As the person skilled in the art will appreciate, the aforementioned components, with the exception of the reader unit 10, are standard components associated with computers and the detailed inter-connection, function and running of these components are readily apparent. All components are connected by appropriate buses.

Referring to FIG. 3, television advertisements for broadcast are processed by a processing unit 51. In this unit, an advert coding and a transmission time coding are inserted prior to the material comprising the advertisement. The advertisement is normally in the form of a video tape. The advertisement coding allows identification of the advertisement, say the third commercial of an available 3 for soap brand XXX.

The coding is located within the television signal as follows, although this is only by way of example based on the transmission system in the United Kingdom. As is known in the art, a television transmission frame comprises a number of lines all coordinated by synchronization pulses. In the United Kingdom, the lines used for picture data are interlaced to give a total of 625 scanning lines. An additional period equivalent to 25 lines is also provided, known an the vertical blanking period, which allows the receiver to flyback to the top of the screen for the next frame. The aforementioned coding can be located within these 25 lines, preferably within lines 7 to 12. The location of these six lines within a received television frame in precise and hence the coding therein can be extracted for use.

Each line can contain 45 bytes of information so that for 6 lines at a frequency of 50 Hz, 13,500 bytes of information per second can be transmitted which is more than adequate for the advert coding and time coding. It is preferred that the coding is repeated cyclically throughout the advertisement run time.

It will be appreciated that the coding can be placed on the video tape of the advertisement by keyboard entry at the advertisers location or at the broadcasters location. Furthermore, the time coding can be placed on the video tape of the advertisement at the advertisers agency or facilities house. However, it is preferred that the time coding is added at the broadcasters location at the time of actual broadcast since this can take account of broadcasting schedule changes.

Thus, the advertisement with the advert coding and time coding is broadcast from a broadcast location 52 along route 53 to a plurality of participant locations 54, to 54ₛ. The route 53 can for example only take the form of broadcasts from a transmitter, a satellite or via cable.

FIG. 2 illustrates the arrangement at the participant location. Each system participant has a data collection unit 20 which comprises a processing unit 21 and a hand hold unit 28. The processing unit 21 has an input 22 connected to a line receiving the transmitted material via route 53, in this case an aerial line 42. The input 22 includes a connection to an output 40 to which a television 41 is connected. Thus, the processing unit 21 is connected into the circuit from the aerial receiving transmitted material to the television and conveniently rests on the television or on the floor below the television.

The input 22 is also connected to a VHF demodulation circuit 23. A tuned signal then passes through a splitter 24 to split off the synchronization signals which are sent to a timing control unit 259 The incoming signal is then sent to a retrieve data unit 26 which retrieves the aforementioned lines 7 to 12 according to timing signals received from the timing control unit 25. The retrieved data is then passed to a data control 27. The data control is also connected to a display 43. A removable smartcard 30 is received in a socket of the processing unit 21 so that a communication link with the data control 27 can be established. The communication link is represented by line 31.

The hand held unit 28 is connected by a line 32 to an input 29 of the processing unit 21 which input is also connected to the data control 27. The hand hold unit 28 comprises a row of at least four switches, as shown by 33, 34, 35 and 36 together with a single push button switch 37.

The connection and use of the data collection unit is as follows. A participant initially receiving the data collection unit connects the aerial line to the input 22 and connects a cable from the output 40 to the television 41. An unused smartcard 30 is then inserted into the processing unit 21. According to the programming of the on board processor of the smartcard, initial processing may take place. Such processing could take the form of unit checks and the display 41 may be activated to show to the participant that the processing unit is operational.

To start storing data of viewing or advertisements, the television is switched on. The hand held unit 28 includes the four switches 33, 34, 35 and 36 and these can be allocated to a named viewer. Thus, once the television is switched on, one of these four switches must be activated to identify who is watching television. As the composition of people watching television alters, the appropriate switches should be activated or deactivated.

A signal representative of the allocated viewer is sent down line 32 to the data control 27 so that the data control has data on the current television viewers. When an advertisement appears on the television, the viewer with the unit 28 depresses push button 37 and keeps the button depressed.

A signal representative of the depression of button 37 is sent down line 32 to the data control 27. As a result, the data control sends to the smartcard the coding data currently being retrieved from the television signal by the unit 26 together with the unique identity of the data collection unit, and the current time as a start time. The composition of the viewers is also sent to the smartcard.

When the data control 27 no longer receives a signal representative that the button 37 is being depressed, the current time as an end time is sent to the smartcard. The on board microprocessor in the smartcard sorts the received data and calculates the attention time of the viewer to each advert. Then, the data is stored in the on-board memory.

To avoid abuse by the viewer taping down the button 37, the power supply for the hand held unit 28 can be provided from a battery (not shown) so that such action would lead to a rapid drain on the battery. As a result, a user abusing the system would have to frequently replace the batteries. Alternatively, a simple cut out could be included which switches off the hand hold unit 37 if continuous depression of the button for longer than, say, 10 minutes occurs.

Thus, after the adverts have finished, a number of advert slots may have been stored according to whether the viewer watched the advert and pressed the button 37. Each advert slot stores the advert coding, the transmission time coding, the attention time, the viewers, the unique identity and the stored current time compared with the transmission coding time. It will be apparent that the manner of storing the data and the sorting thereof can be selected according to the provider of the hand held unit 28.

The smartcard can include a formula for converting attention time to points according to a predetermined system. The conversion can be made for each advert slot stored or a running total can be kept. The processing unit 21 can be made such that it can interrogate the smartcard 30 so that the number of points thereon can be retrieved and displayed on the display 43.

Periodically, the processing unit 21 interrogates the smartcard to check whether the on board memory has a sufficiently reduced memory capacity corresponding to it being effectively full. Then, the processing unit 21 can actuate a flashing display or other signal on the display 43 to alert the participant that the loaded smartcard should be posted to the central controller 1 and replaced with a spare smartcard.

The hand held unit 28 may be used for capturing information that is retrieved from the received transmission material by the retrieve data unit 26. When a viewer sees information of personal interest on the television screen, for example a telephone number, by depressing a button 44 on the hand hold unit 28, a signal is sent down line 32 to the data control 27. As a result, the telephone number is retrieved from the received transmission and is displayed on the display 43. It will b appreciated that the telephone number is embedded in the received transmission in a similar manner to the advert coding. The processing unit 21 may include a printer drive unit so that the information can be printed out on paper. The processing unit may also or alternatively include scrolling buttons for reviewing the stored data on the display 43.

The overall operation of the data collection system will now be described. Initially, potential participants of the system are sent a questionnaire containing questions relating to socio-geodemographic factors, in a similar form to known market research questionnaires. For example, such questions would be directed to personal characteristics of the participant, household characteristics, financial information etc. The questionnaire would also explain that by having and using the data collection unit, the participant can derive something of value e.g. financial gain, perhaps in terms of money equivalent vouchers, benefit, coupon., discounts, discount points, or money itself.

A participant interested in joining the system returns the questionnaire. The new participant is allocated a unique identity code and the participant data is retrieved from the completed questionnaire and is entered into the participant data store 7, with an association with that identity code. The entry of such data is by means of the keyboard 5, although other manners of data entry could be employed. The participant is then sent a data collection unit 21, 28 which is allocated the unique identity code. As more and more new participants join the system, an information database about the participants is built up.

As the participants view advertisements, as described above with reference to FIG. 2, full smartcards 30 are returned by post to the central controller 1. The returned smartcards are inserted into the reader 10 where the data of the stored advert slots are read under the control of the CPU 2. The data stored on the card is read and transferred into the viewing data store a according to the identity code. The CPU 2 can check the validity of the data in a number of ways. For example, in the present case, it can check that the advert coding and transmission timing coding of the advert slots that were stored on the smartcard are consistent with advert coding and transmission timing coding pre-loaded In the transmission store 11. In this way, it is possible to ascertain that the viewer has watched all or part of the advertisements during the course of transmission as opposed to on videotape. It will be apparent that other checks can be made to ensure that participants do not abuse the data collection system.

When the central controller 1 ascertains that the smartcard data is valid, it checks the amount of valid data retrieved and according to a predetermined formula, allocates a value amount to that retrieved data. Then, by accessing the participant data store 7 according to the unique identity on the smartcard, the central controller can obtain the name and address of the participant who returned the card and, if desired, automatically print an appropriate letter and, for example, a voucher from the printer 9.

As smartcards are returned from an increasing number of participants, an accurate database of viewing data can be built up in the viewing data store 8. The data in the viewing data store 8 can be processed as raw data or alternatively, it can be cross referenced with the date in the participant data store by use of the unique identity.

Thus, by entering suitable search parameters, the central controller can access the stores 7 and 8 together with the transmission store 11 and extract a variety of information. The following are just some examples of the data that could be retrieved:

a) the number of participants who watched adverts on a specific date;

b) the number of participants who watched adverts of a certain advert code and/or transmission time coding on a specific date;

c) further analysis of a) or b) according to selected socio-geodemographic factors of the participant data.

With such information, it is possible to provide advertisers, broadcasters and their agencies with valuable information allowing them to assess the impact or adverts in raw terms of way overall numbers or to assess the impact of adverts in more refined terms of, say, socio-geodemographic grouping. Indeed, targeting of commercials can be effected. Individuals or households can then be selected or deselected within the central controller for direct marketing purposes or indeed the sale of names and addresses and information held on the central control within the limitations of data protection and other privacy protection laws.

It will be appreciated that the above embodiment of the present invention is capable of considerable modification. For example, whilst the reader 10 reads received smartcards, the reader could read the data collection units at the participant location by using, say, modem connection or the like. Furthermore, the degree of sophistication for the participant data and viewing data can be selected as required. For example, the switches 33 to 36 can be omitted so that the hand held unit 28 is not able to communicate the composition of viewers in a room to the processing unit 21. In addition, the communication between the hand held unit 28 and the processing unit 21 can be by means of intrared sitters and receivers.

FIGS. 4 to 7 illustrate a second embodiment of the present invention. Referring to FIGS. 4 to 6, there is illustrated the arrangement at the participant location. The data collection unit comprises a processing unit 100 and a hand held unit 101. The processing unit 100 is located on the top of a participant's television 102 and is connected by a cable 104 to the so-called SMART connector thereof. The television is connected to receive signals via an aerial 103.

As can be seen from FIG. 5, the front face of the rectangular shaped processing unit 100 has a display area 106 located above an infrared receiving window 105 and a smartcard receiving slot 127. To the right of the display area 106 and window 105, there are provided a power indicator 107 and an ON/OFF switch 108.

As can be seen from FIG. 6, the hand hold unit 101 comprises a box having a generally rectangular form with one end narrowed or contoured to conveniently fit a hand. At the narrowed end, there is provided an infrared transmitting window 109 which when pointed at the window 105 allows communication between the hand held unit 101 and the processing unit 100. At the location where the narrowed end starts, approximately two thirds of the way along the length of the hand hold unit 101, there is provided a left push button 110 on the loft edge of the unit 101 and a right push button 111 on the right edge of the unit 101. At the end remote from the narrowed end, there is provided a telephone number recall button 112 and a text recall button 113 with a tilt UP/DOWN button 114 provided adjacent thereto. The function of these button& will be explained hereinafter.

A plurality of lights 115 are provided in the upper surface of the unit 101, in this case five lights. These lights can be labelled to identify the identity of the viewers watching the television.

As is known in the art, before transmission of an advert, certain encrypted information can be incorporated into an advert. In the present case, the data would be contained with one line of the vertical blanking interval, generally lines 7-9 and 18-22. The insertion of such information can normally takes place at the “Library Logging” or dubbing suite stage using a multi-tasking computer and data bridging equipment prior to transmission on a real time basis. The detailed manner by which such information is incorporated does not concern the present invention. However, reference may be made to the Independent Television Commission Rules of Operation for the use of the ITU-R (CCIR) Teletext System B.

With the present invention, the information taken the form of 80 characters which are transmitted every second so that it appears in the vertical blanking line. The first 15 characters of the information comprise the electronic verification of transmission number (the EVT number). The first three alpha numeric characters denote the agency which prepared the advert. There is then a forward slash (/). The next four alpha numeric characters denote the client whose product is being advertised followed by three numeric characters which denote the particular advert. There is then a forward slash (/). The next three numeric characters denote the length of the commercial. For example ADV/KLNX012/020 indicates advertising agency code ADV has prepared advert number 012 for a product identified as KLNX and the advert lasts 20 seconds.

The remaining characters in the information transmitted comprises a real time transmission clock together with a section for information such as telephone numbers, addresses, text such as recipes, vote YES/NO, flashing of lights, winning numbers etc.

Referring to FIG. 7, the processing unit 100 comprises a decoder section 120 which is connected to the cable 104. A main processor (CPU) 121 is connected to receive the information decoded by the decoder section 120 along with signals from a real time clock 160. It will be appreciated that the decoder section can incorporate an encryption algorithm having a plurality of settable keys so that the system is secure. The CPU 121 is also connected to the display 106 and an optional printer driver and printer 122. An infrared sensor 123 is located in the window 105 and is connected to the CPU 121 via an infrared decoder 124. The CPU 121 is also connected to a smartcard 125 via an interface 126. The smartcard 123 can be loaded into the processing unit via the slot 127 in the front face thereof. Finally, a memory 128 and flash EPROM 129 are connected to the CPU 121. The processing unit 100 is powered by a main power supply schematically illustrated by the reference numeral 130.

To use the system in a television medium, consumers or participants must register with the central facility, in the present case, the central controller shown in FIG. 1 can be employed. Their viewing habits can be recorded and analyzed for television audience research purposes. A detailed household information and lifestyle survey would be completed by the household and individual members. Once the survey is received and their details entered onto the a database in the store 7, a personalised hand hold unit and processing unit are forwarded to then. This unit will have a unique identity code or number corresponding to the household. When the unit is connected and a smart card has been inserted, operation of the power switch 108 causes the software to enquire who is watching the television. By a suitable manipulation of the buttons on the hand hold unit, it is possible to communicate who is viewing to the processing unit. The manner by which this can be achieved can take manner forms, the detail of which will be readily apparent to a person skilled in the art. For example, a button along side each name could be provided.

The data collection unit is then ready. When adverts appear on the television 102, the viewer presses either of the buttons 110 or ill for the entire duration of the advert. This will have the effect of earning points for the viewer in the following manner. When the CPU 121 receives from the infrared decoder sensor 124 a signal indicating that the buttons 110 or 111 have boon pressed, the CPU 121 stores onto the smartcard 125 the information being decoded by the decoder 120.

The information stored on the smartcard 125 comprises a number of headings. In a simple form, the headings comprise the EVT number and the transmitted real time together with the date and real time supplied by the CPU 121. The data that is actually stored can be in an un-encrypted form or an encrypted form. Naturally, some resetting of the CPU clock with the transmission clock will be required at some time each day or week. Each second of a commercial that is viewed is allocated 1 point and the registering or these points is displayed on the display 106. A cumulative total is also displayed.

Once the smartcard 125 is full, the CPU 121 makes the display 106 display a “CARD FULL” message. Typically, the smartcard can store information relating to 25,000 points which is estimated to be about 2 weeks viewing of adverts. The viewer then takes out the full smartcard and replaces it with their spare card. The full card is then posted to the central controller and downloaded as with the first embodiment.

At the central controller facility, the points are allocated to the unique identity code on the smartcard. A regular statement of points can be sent to the user or tokens.

In a more sophisticated form of the present invention, a hand held unit 101′ is employed as shown in FIG. 8. Components common between FIGS. 6 and 8 bear common reference numerals. In this case, further headings can be stored alongside the above headings. For example, they could include points collected, telephone/addresses, points wagered, votes cast, purchases, coupons and text.

If the viewer also wishes to store the optional additional information or interact with the transmitted information, for example by voting, they depress the YES button 150. The additional information is then stored in the smartcard 125 and if appropriate this information is stored into the flash EPROM 129. Typically, the EPROM 129 overwrites itself once a capacity has been reached, for example 10 telephone numbers of 960 characters of text. The user can scroll through this stored information by depressing a select button 151 and the UP/DOWN button 114.

When the information downloaded at the central facility, it is possible to correlate the voting, wagering and other forms of interaction with the television against the unique identity code on tho smartcard so that voting patterns, purchases etc can be correlated as well as any purchase or wager put into effect.

It can be seen therefore that the interaction between the viewer and the television allows a considerable number of responses in a simple and cost effective manner.

The issue of points can also be directly related to a mail order provider of goods. In addition, special sales can be run by that provider and the user can indicate a desire to purchase sale goods during an advert by pressing the button 110 or 111.

As a form of security to prevent fraudulent use, the processing unit 100 can have left and right lights which can be lit according to a left or right flag associated with the EVT number. Thus, the user must depress either the left button or the right button to store points. The depression or the appropriate button with the flag can be monitored by the CPU to check that both buttons have not been stuck down. Indeed, special bonuses could be provided in the Case of both lights being lit.

Thus, with the present invention, the viewer does not need to interrupt viewing to phone telephone numbers of write thou down since no paper or pen is required or memorisation. In addition, the viewer can earn points simply be viewing whilst a marketing database can be built up for market research and direct marketing purposes. For the broadcaster, the present invention enables research of the most popular programmes/adverts.

Whilst the above description has been directed to advertisements on television, the present invention can be applied to programme material. It will also be appreciated that the term “transmitted material” can take the form of at least television transmission and radio transmission, and the material can be transmitted via broadcast networks such as satellite transmissions, local antennas or via cable, telephone lines etc.

1. A data collection system for collecting data concerning participant response to received transmitted material, the system comprising:
a plurality of data collection units distributed, in use, to remote system participants, wherein each said data collection unit has a unique identity and comprises:
a receiving means for receiving the transmitted material;
an information storage means; and
a response means responsive to a manual operation of the unit to store date of a portion of the transmitted material to the information storage means of that unit;
wherein the system further comprises a central controller having means for storing data relating to system participants according to said unique identity; means for reading the unique identity of a data collection unit information storage means; and means for reading the data that has been stored thereon in response to manual operation of that unit.

2. A system according to claim 1 wherein the data collection unit further comprises a display means.

3. A system according to claim 2 wherein said unit actuates said display means to display a predetermined indication when the volume or data stored by the information storage means has reached a predetermined capacity.

4. A system according to claim 3 wherein the predetermined capacity corresponds to an average volume of data stored by a participant for a period of one to twelve weeks.

5. A system according to any one of claims 2 to 4 wherein the data collection unit further comprises a memory means and said response means is responsive to a manual operation of the unit whereby data of a portion of the transmitted material is stored by the memory means of that unit.

6. A system according to any one of claims 2 to 5 wherein the data collection unit further comprises a manually operable display switch means for actuating the data collection unit to operate to display stored data.

7. A system according to any preceding claim wherein said information storage means is removable from the data collection unit to enable physical sending thereof to the location of the central controller.

8. A system according to any preceding claim wherein said information storage means comprises a smartcard.

9. A system according to any one of claims 1 to 6 wherein said means for reading comprises an electronic receiving means for remote communication with said information storage means.

10. A system according to any preceding claim wherein the data collection unit is manually operated by manually operating a push switch.

11. A system according to any preceding claim wherein the response means stores said data to the Information storage means only during continuous manual operation of that unit.

12. A system according to any preceding claim wherein the response means allocates units and/or units of time during storing said data to the information storage means.

13. A system according to claim 12 wherein said unit of time comprises one second.

14. A system according to claim 12 or 13 wherein the means for reading data can read the accumulated units of time allocated during storing data and said central controller allocates a value amount according to the total accumulated units.

15. A system according to claim 14 wherein said value amount comprises a monetary value, benefit, discount, discount points, benefit, or monies worth.

16. A system according to any preceding claim wherein said means for receiving includes means for decoding the transmitted material; wherein the transmitted material includes a coded section for identifying that transmitted material.

17. A system according to claim 16 wherein said coded section includes transmission time and date information; and wherein the response means stores the transmission time and data information with the data stored to the information storage means.

18. A system according to claim 16 or 17 wherein the data collection unit further comprises a clock means; and wherein said response means stores the unit time and date with the data stored to the information storage means.

19. A system according to any preceding claim wherein each data collection unit has a separate manually operable hand held unit whereby the response means in responsive to a manual operation of the hand hold unit.

20. A system according to claim 19 wherein the hand hold unit communicates with the response means by means of an infrared communication link.

21. A system according to claim 19 or 20 wherein the hand hold unit is capable of supplying the response means with user data concerning the number of current users at the participant location; and wherein the response and stores that user data with the data stored to the information storage means.

22. A system according to any one of claims 19 to 21 wherein the hand held unit comprises a left dedicated switch and a right dedicated switch whereby the response means is responsive to a manual operation of the left and/or right dedicated switch.

23. A system according to claim 22 wherein the response means is only responsive to a manual operation of the left and/or right dedicated switch according to switch data contained in the transmitted material.

24. A system according to claim 23 wherein the data collection unit comprises a left light and a right light actuated according to said switch.

25. A system according to any preceding claim wherein the data collection unit further comprises a printer means.
